(19) United States
(12) Patent Application Publication
(10) Pub. No.: US 2003/0090098 A1
(43) Pub. Date: May 15, 2003

(54) Support structure for a vehicle with attached fitting and method of making same

(76) Inventors: Karl-Heinz Baumann, Bondorf (DE); Ulrich Bruhnke, Ehningen (DE); Jurgen Kohler, Aidlingen (DE); Uwe Krempels, Boblingen (DE); Hansjorg Schinke, Holzgerlingen (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/043,277

(22) Filed: Jan. 14, 2002

(30) Foreign Application Priority Data
Nov. 13, 2001 (DE) 10101339.6

(51) Int. Cl. B62D 21/00

(52) U.S. Cl. 280/781

(57) ABSTRACT

A support structure for a vehicle is comprised primarily of multi-walled lightweight panels with plane-parallel flat sides, and at least one fitting can be fastened to the support structure. An opening is cut out of a lightweight panel of the support structure that is designated for the fitting, and the fitting can be installed in this opening, covering the opening completely. A support arrangement attached to the fitting operates in conjunction with the edge of the opening in the lightweight panel as an installation stop for the fitting.

### BACKGROUND AND SUMMARY OF THE INVENTION

The invention relates to a support structure for a vehicle comprised primarily of multi-walled lightweight panels having plane-parallel side surfaces, with at least one fitting mountable on the support structure,

From German Patent Document No. DE 199 17 177 A1, a vehicle support structure is known which is predominantly comprised of multi-walled, relatively thick, lightweight panels with plane-parallel side surfaces. Fittings, such as seats, mechanical elements etc., are mounted to the side surfaces of the lightweight panels of the support structure.

It is an object of the invention to provide a support structure of the type described above that will accommodate the mounting of the fittings in a space-saving and simple manner.

This object is achieved according to certain preferred embodiments of the invention by providing a vehicle support structure comprised primarily of multi-walled lightweight panels having plane-parallel side surfaces, with at least one fitting mountable on the support structure, wherein an opening is cut out of a lightweight panel in the support structure, designated for a specific fitting, wherein the fitting can be inserted into this opening such that it covers the opening completely; and wherein a support arrangement on the fitting operates in conjunction with an edge of the opening in the lightweight panel to limit the insertion of said fitting.

According to certain preferred embodiments of the invention, an opening is cut out of a lightweight panel in the support structure that is allocated to a fitting, and the fitting can be inserted into this opening. In this manner, the space created by the opening in the lightweight panel, which is usually relatively thick, can be utilized for the fitting without this resulting in any significant weakening of the lightweight panel. In contrast to the conventional method of mounting fittings to a sheet steel car body, no additional reinforcement is necessary; instead, the special properties of car bodies, consisting in the areas to which fittings are allocated of inherently rigid, double-walled lightweight panels can be purposefully utilized.

In certain preferred embodiments of the invention, a support arrangement is envisioned as a limit stop on the fitting, comprised, for example, of taps or flanges that will allow for easy mounting and precise inserting of the fitting. The direct planar connection of the fitting to the double-walled lightweight panel further allows for simple mounting that is very rigid and has a high load capacity.

The arrangement of the fitting in a lightweight panel limiting the passenger area inside the vehicle has proven especially advantageous according to certain preferred embodiments of the invention, since experience has shown that the space available for fittings in that area is very limited. It is particularly advantageous if the fitting is arranged according to the invention in the lightweight panel of a support box on the front end of the support structure, since many mechanical elements, such as steering components, pedal components, electrical housings etc., must be arranged in that area in a very limited amount of space.

It has been a particularly effective space-saving measure according to certain preferred embodiments of the invention to arrange the fitting in a lightweight panel that is covered with the outer plating of the vehicle. In this way, it is possible to optimally utilize the space between the lightweight panel and the outer plating for the fitting.

A rotary or surrounding mounting flange allows for an especially effective planar connection between the fitting and the lightweight panel according to certain preferred embodiments of the invention. In the area around the opening the lightweight panel can be easily reinforced with the mounting flange. An additional reinforcement of the lightweight panel and an optimal utilization of the opening result, if the diametric cross section of the opening is adjusted with the penetrating cross section of the fitting.

A fitting that is held in place in its contact position on the lightweight panel via a ring flange that is slid on over the end of the fitting, which protrudes through the opening, is especially easily mounted according to certain preferred embodiments of the invention.

Other objects, advantages and novel features of the present invention will become apparent from the following detailed description of the invention when considered in conjunction with the accompanying drawings.

### BRIEF DESCRIPTION OF THE DRAWINGS

FIG. 1 is a perspective view of a vehicle support structure, viewed from above at an angle and comprised primarily of planar lightweight panels, constructed according to a preferred embodiment of the invention;

FIG. 2 is a perspective view of the support structure shown in FIG. 1, viewed from the front at an angle and in part covered with sections of plating;

FIG. 3 is a perspective view of a section of a support box in a vehicle support structure showing an opening cut out of one side wall of the support box in order to accommodate a fitting, constructed according to a preferred embodiment of the invention;

FIG. 4 is a cross section through the wall of a support box including the fitting which is positioned inside the opening and seen along the line IV-IV in FIG. 3;

FIG. 5 is a perspective view of a section of a support box, showing an opening cut out of a front wall of the box to accommodate a fitting that is realized as a subassembly with a pedal, constructed according to a preferred embodiment of the invention;

FIG. 6 is a perspective view of a section of a support box, showing an opening cut out of an upper panel of the support box to accommodate a fitting that is realized as a steering console, constructed according to a preferred embodiment of the invention;

FIG. 7 is a section through the upper panel including the steering console that is arranged inside the opening, taken along the line VII-VII in FIG. 6;

FIG. 8 is a perspective view of a section of a support box, and showing an opening cut out of the upper panel to accommodate an installation module of a windshield wiper assembly, constructed according to a preferred embodiment of the invention; and

FIG. 9 is a section through a lightweight panel of a support structure with an opening in which a housing for electrical components is installed, and an electric line runs through a hollow channel in the lightweight panel to the housing, constructed according to a preferred embodiment of the invention.

### DETAILED DESCRIPTION OF THE DRAWINGS

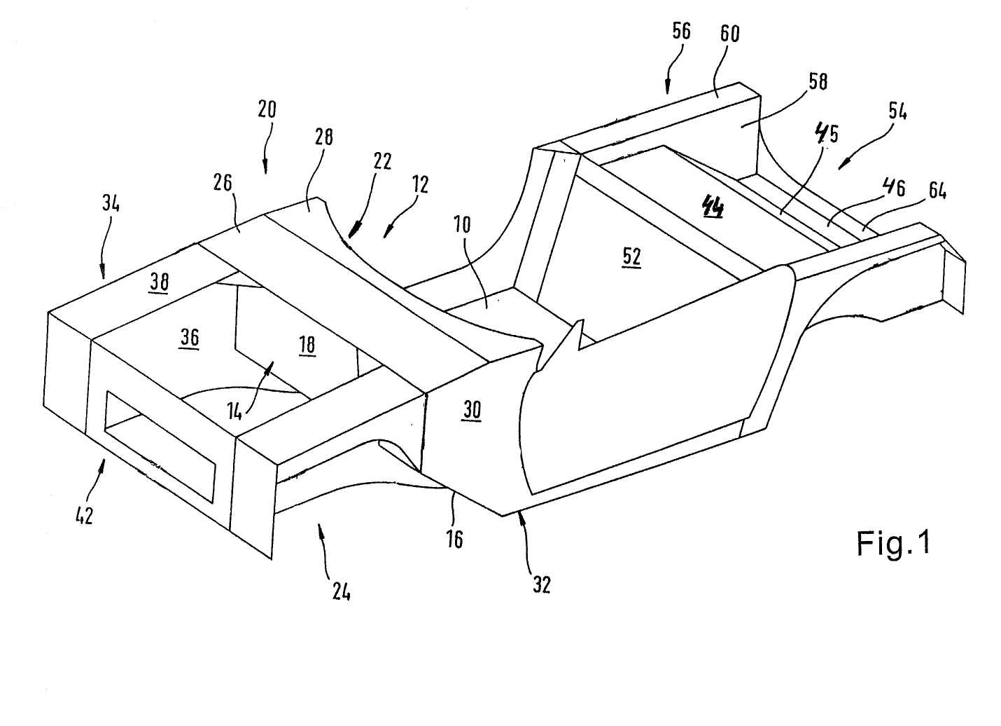

FIG. 1 shows a perspective view of a vehicle support structure, viewed from above-front and at an angle, which is comprised of a supporting base 10 made of a lightweight panel. The support structure, described in greater detail below, comprises primarily energy-absorbent, inherently rigid and flat lightweight panels, that are preferably manufactured, depending on the requirements, as a sandwich construction, with a honeycomb structure, from wood, from aluminum, as a fiber composite, as an extruded profile etc. To achieve favorable manufacturing conditions, the individual panel sections can be designed as one-piece units that are assembled as bent or as multiple parts creating joints. In the front, in the area designated for passenger leg room 12, the base 10 extends to a front wall 14, which comprises a transition area 16 that is connected to the base 10 and extends at an upward angle toward the front and an area 18 arranged above the transition area and extending approximately vertically. To the sides and above, the leg room area 12 is limited by a panel arrangement 20, which, together with the base 10 and the front wall 14, forms a support box 22 for a front-end structure 24 that is fastened to the support box. The panel arrangement 20 includes a front and a rear upper lightweight panel 26, 28 and support box side walls 30, forming a lateral limitation for the leg room area 12 and each of them forming part of a side wall 32 of the support structure.

The front-end structure 24 comprises two front-end side panels 34, each of which with one vertical and one panel leg 36, 38 extending diagonally in relation to the former. At the front end of the side panel 34, a front-end panel 42 is mounted, which extends crosswise to the direction of travel and is oriented vertically. The side walls 32 extend forward up to the front-end panel 42 and are equipped with cutout areas to accommodate the tires.

In the rear, the base 10 merges into a rear dividing wall 52 that extends toward the rear, tilted upward at an angle, and between the side walls 32. Behind the rear dividing wall 52, the support structure is equipped with a rear end structure 54 with rear side panels 56, each of which has two angled panel legs 58, 60 one extending vertically along the vehicle and the other extending horizontally along the vehicle. At the rear end of the rear side panel 56, a vertical rear end panel 64 is mounted, which extends across the vehicle. The rear side panels 56 are rigidly fastened to one another via a panel arrangement comprised of lightweight panels 44, 45, 46, which together form a box.

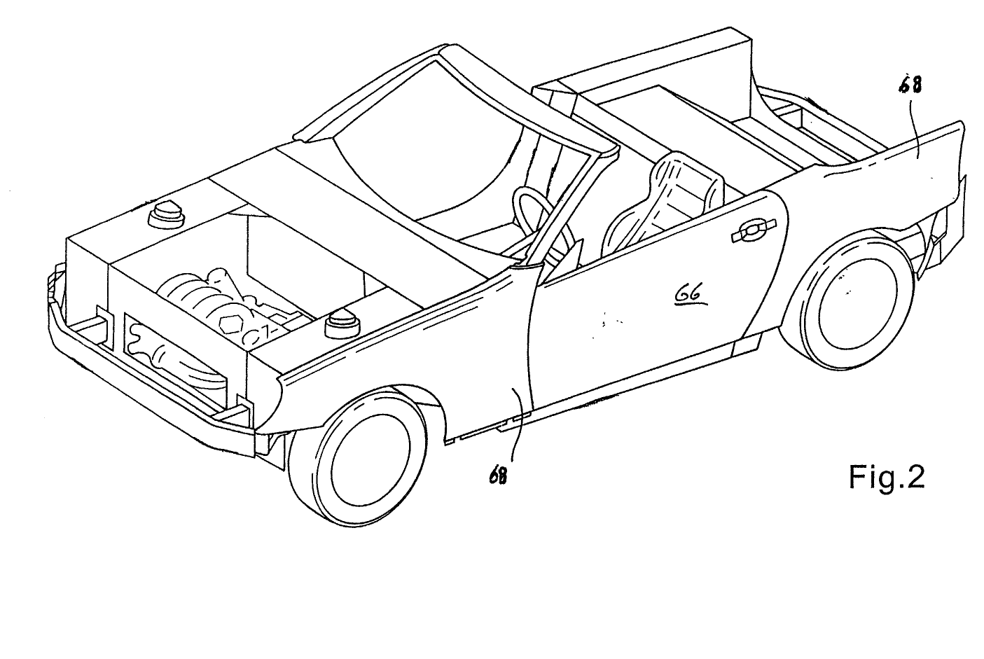

In FIG. 2, a perspective view of the support structure depicted in FIG. 1 is shown. In this case it is covered with plating; the drawing shows plating units 68 mounted to corresponding retainers in the support structure, covering the left front and rear fenders and a plating unit 66 covering the side wall.

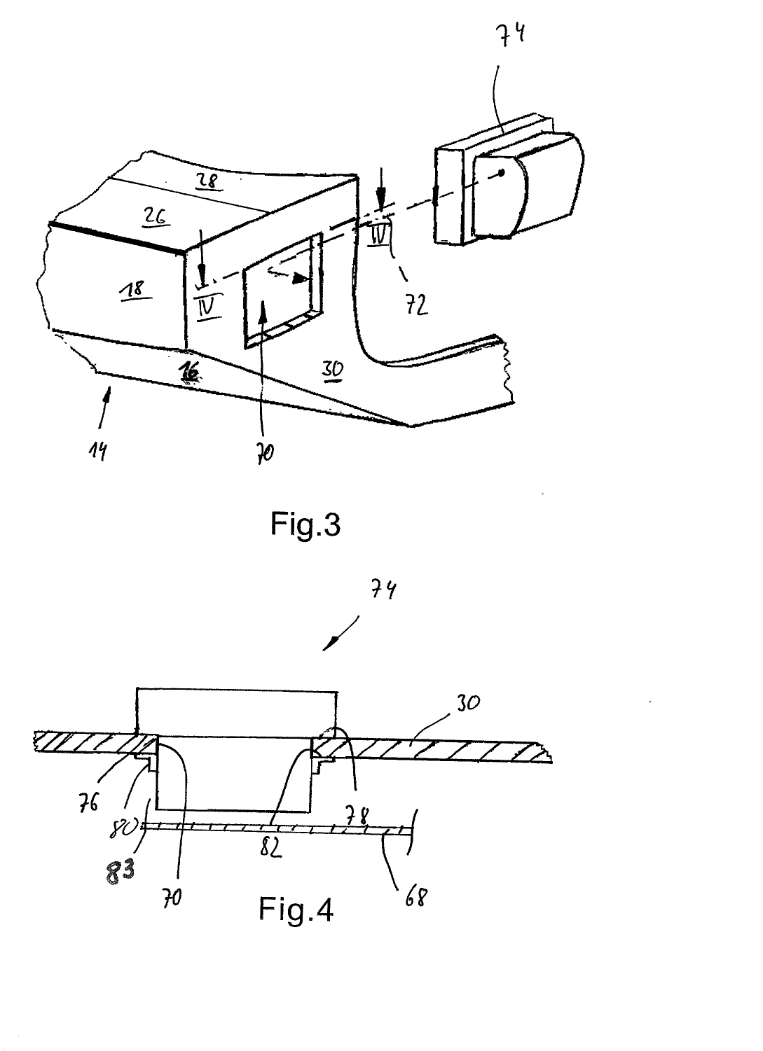

FIG. 3 shows a perspective view of a section of the support structure in the area of the support box 22, including sections of the left side wall of the support box 30, the transition area 16 and the vertical area 18 of the front wall 14, along with the upper panels 26 and 28. An opening 70 is cut out of the support box wall 30, into which—as indicated by the dashed arrow 72—a fitting 74 can be inserted; the fitting will then cover the opening 70 completely. In this case, the fitting 74 is realized as a housing for electrical components, e.g. as a fuse box.

When viewed in conjunction with FIG. 4, in which a cross section through the support box wall 30 along the line IV-IV in FIG. 3 with the opening 70 is shown, the arrangement of the fitting 74 within the opening 70 becomes apparent. The fitting 74 is equipped with a support arrangement comprising a rotary mounting flange 76, which acts in conjunction with the edge of the opening 78 in the lightweight panel 30 as an installation stop for the fitting 74. The dimension of opening 70, which in this case is rectangular, is designed specifically to accommodate the penetrating cross section of the fitting 74. The fitting 74 is held in place on the lightweight panel 30 via a ring flange 80 with an L-shaped cross section. The ring flange 80 is slid, from the outside, over the end of the fitting 74 that protrudes through the opening 70 toward the outside. For purposes of fastening the fitting 74, the ring flange 80 is supported on the outside, along the edge of the opening 82, against the side of the lightweight panel 30 that faces the mounting flange 76. In addition to, or as an alternative to, the ring flange 80, the fitting 74 can be mounted on the support box wall 30 via an adhesive—applied, for example, between the mounting flange 76 and the allocated edge of the opening 78. The fitting 72 may also be screwed or clipped to the lightweight panel 30 or the ring flange 80. The mounting flange is preferably constructed such that it serves to reinforce the lightweight panel 30 in the area of the opening 70. The support box wall 30 that is equipped with the fitting 74 is covered by the left front fender plating unit 68, which is illustrated in FIG. 2 and indicated in cross section in FIG. 4; the fitting 74 extending into the space 83 between the lightweight panel 30 and the plating unit 68.

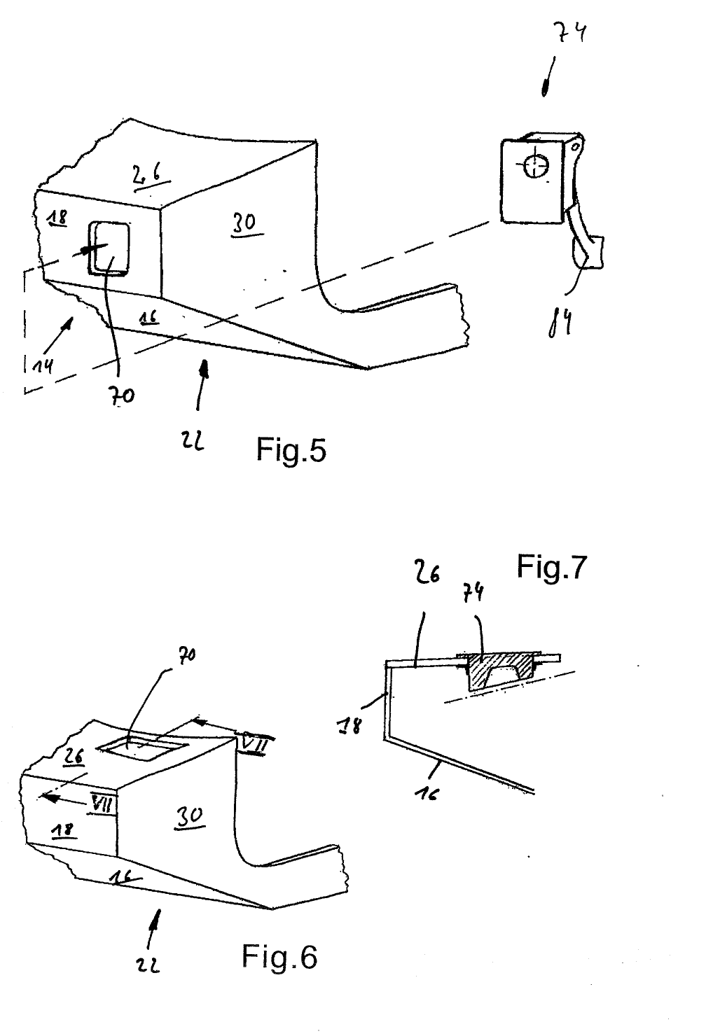

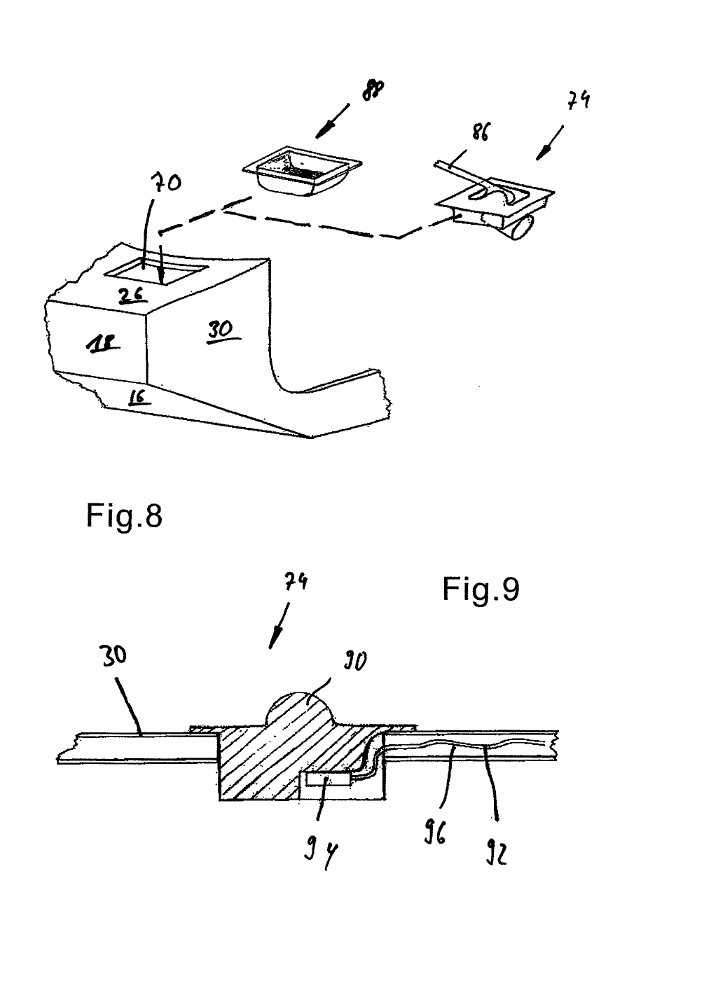

FIG. 5 shows another perspective view of a section of the support box 22, including the support box side wall 30, the front wall 14 and the upper panel 26. The fitting 74 in this case is envisioned as a subassembly with a pedal 84, which—as indicated by the dashed arrow—can be inserted from the front into an opening 70 that is cut out of the end wall 14 or out of its vertical section 18 and can be secured in its installed position in the manner described above.

FIGS. 6 and 7 show a perspective view of a section of the support box 22 with the opening 70 in the upper panel 26 and a sectional view along the line VII-VII in FIG. 6 with the fitting 74 inserted into the opening 70. In this case, the fitting 74 is envisioned as a steering console, which is inserted into the opening 70 from above.

FIG. 7 shows—as indicated by the dashed arrow—that an inserted module 74 of a windshield wiper assembly 86 can be inserted into the opening 70 in the upper panel 26, or a fitting that is envisioned as a tray 88 can be inserted into the opening 70. If the arrangement involving the windshield wiper assembly 86 is envisioned, then the windshield, which is not illustrated here, must be positioned correspondingly behind the opening 70 at the rear end of the panel 26. If the arrangement involving the tray 88 inside the vehicle is envisioned, then the windshield must be positioned correspondingly in front of the opening 70 at the front end of the panel 26.

In FIG. 9, a cross section of a lightweight panel, such as the support box wall 30, is shown, with the opening into which a housing 90 for electrical components is inserted as the fitting 74. The components in this housing 90 are connected, e.g., via a plug-type connector 94 to an electrical line 92, which runs inside a hollow channel 96 in the lightweight panel that holds the fitting 74. The lightweight panel 30 is preferably produced from an extruded section to comprise a multitude of hollow chambers 96.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. Vehicle support structure comprised primarily of multi-walled lightweight panels having plane-parallel side surfaces, with at least one fitting mountable on the support structure, wherein an opening is cut out of a lightweight panel in the support structure, which opening is designated for a specific fitting,
wherein the fitting can be inserted into this opening such that it covers the opening completely; and
wherein a support arrangement on the fitting operates in conjunction with an edge of the opening in the lightweight panel to limit the insertion of said fitting.

2. Vehicle support structure according to claim 1, wherein the fitting is inserted into a lightweight panel that limits a passenger space inside a vehicle.

3. Vehicle support structure according to claim 2, wherein the fitting is inserted into the lightweight panel of a support box, and the support box is comprised of a base area 10, a front wall and a panel arrangement that limits a front leg room area at the sides and above.

4. Vehicle support structure according to claim 1, wherein the lightweight panel that is equipped with the fitting is covered by an outer vehicle plating unit, with the fitting projecting into a space between the lightweight panel and the plating unit.

5. Vehicle support structure according to claim 1, wherein the support arrangement of the fitting comprises a mounting flange which serves to reinforce the lightweight panel in the area around the opening.

6. Vehicle support structure according to claim 1, wherein the cross section of the opening is designed to accommodate a penetrating cross section of the fitting.

7. Vehicle support structure according to claim 1, wherein the fitting is fastened to the lightweight panel via the support arrangement.

8. Vehicle support structure according to claim 7, wherein the support arrangement is fastened to the lightweight panel via an adhesive bond.

9. Vehicle support structure according to claim 1, wherein the fitting is held in place in its contact position on the lightweight panel via a ring flange, and
wherein the ring flange is slid over the end of the fitting that protrudes through the opening and is supported at the edge of the opening against the side surface of the lightweight panel that faces the support arrangement.

10. Vehicle support structure according to claim 3, wherein the fitting is a subassembly with a pedal.

11. Vehicle support structure according to claim 3, wherein the fitting is a steering console.

12. Vehicle support structure according to claim 1, wherein the fitting is a housing for electrical components.

13. Vehicle support structure according to claim 12, wherein the components are connected via electrical lines which are held in hollow channels in the lightweight panel that is assigned to the fitting.

14. Vehicle support structure according to claim 3, wherein the fitting is an insertion module for a windshield wiper assembly.

15. A passenger vehicle assembly comprising:
a plurality of planar light weight panels of a multi wall sandwich honeycomb construction connected together to form a passenger space section bounded by said panels, one of said panels having an opening with a predetermined shape and size, and
a fitting operable to support a vehicle device, which fitting is carried by the one of said panels,
wherein said fitting has a flange adjacent an insertion portion with a predetermined shape and size corresponding to the opening in said one of said panels to accommodate insertion of said fitting in said opening with said flange limiting the insertion movement of the fitting and forming a support surface for fixing the fitting to the one of said panels.

16. A passenger vehicle assembly according to claim 15, wherein the lightweight panel that is equipped with the fitting is covered by an outer vehicle plating unit, with the fitting projecting into a space between the lightweight panel and the plating unit.

17. A method of making a passenger vehicle assembly comprising:
providing a plurality of planar light weight panels of a multiwall sandwich construction connecting the panels to one another to form a vehicle passenger space section,
providing a through opening in one of said panels,
providing a fitting operable to support a vehicle device, said fitting including a planar flange section and an insertion section protruding from one side of said planar flange section, said insertion section having a shape and size corresponding to said through opening, and
attaching said fitting to said one of said panels by inserting said insertion section into said through opening with said flange attaching a planar surface of the one of said panels and then fixing said flange and planar surface together.

18. A method according to claim 17, wherein said fixing includes applying an adhesive bond between said flange and said planar surface.

19. A method according to claim 17, comprising attaching a ring flange to said insertion section at an opposite side of the through opening from the flange of the fitting.

20. A method according to claim 17, wherein said flange is operable to reinforce the panel around said through opening.

21. A method according to claim 17, wherein the fitting is a subassembly with a pedal.

22. A method according to claim 17, wherein the fitting is a steering console.

23. A method according to claim 17, wherein the fitting is a housing for electrical components.

24. A method according to claim 23, wherein the components are connected via electrical lines which are held in hollow channels in the lightweight panel that is assigned to the fitting.

25. A method according to claim 17, wherein the fitting is an insertion module for a windshield wiper assembly.
